(19) United States
(12) Patent Application Publication
(10) Pub. No.: US 2021/0165253 A1
(43) Pub. Date: Jun. 3, 2021

(54) LIQUID CRYSTAL DISPLAY PANEL AND DISPLAY DEVICE THEREOF

(71) Applicant: SHENZHEN CHINA STAR OPTOELECTRONICS TECHNOLOGY CO., LTD., Shenzhen, Guangdong (CN)

(72) Inventors: Jianzhong HU, Shenzhen, Guangdong (CN); Kecheng XIE, Shenzhen, Guangdong (CN); Yang Zhang, Shenzhen, Guangdong (CN); Junzheng LIU, Shenzhen, Guangdong (CN)

(21) Appl. No.: 16/615,812

(22) PCT Filed: Sep. 6, 2019
(86) PCT No.: PCT/CN2019/104609

§ 371 Date: Nov. 21, 2019

(30) Foreign Application Priority Data
Jul. 22, 2019 (CN) 201910659217.6

(51) Int. Cl. G02F 1/1339; G02F 1/1335; G02F 1/1343; G02F 1/1337

(52) U.S. Cl. CPC G02F 1/1339; G02F 1/133514; G02F 1/133512; G02F 1/133723; G02F 1/134309

(57) ABSTRACT

The present invention relates to a liquid crystal display panel and a display device thereof, which removes one of electrodes that forms an electrolytic cell by setting a second electrode layer of the non-display area into a plurality of electrode line segments spaced apart from each other, and also reduces a relative area of the second electrode layer to the first electrode layer, such that electrochemical corrosion of a fan-out area caused by formation of the electrolytic cell can be avoided, and thus the reliability of the product is improved. Since the gap between the electrode line segments of the second electrode layer is filled with the material same as that used for the second polyimide layer, the thickness of the second polyimide layer is increased, such that protection of second the electrode layer is increased, ensuring a normal conversion of the signal and improving the reliability of the product.

### BACKGROUND OF INVENTION

### Field of Invention

The present invention relates to a field of display technologies, and in particular, to a liquid crystal display panel and a display device thereof.

### Description of Prior Art

A display device can convert data of the computer into various characters, numbers, symbols or intuitive images, and one can input commands or data into the computer by using an input tool such as a keyboard, such that a display content can be added, modified, or changed at any time by means of the hardware and software of the system. The display device is classified into a plasma display device, a liquid crystal display device, a light emitting diode display device, and a cathode ray tube display device depending on the display component used.

The cathode ray tube (CRT) display works by heating the filament after energization, exciting the cathode, emitting an electron flow, accelerating the electron flow by an internal metal layer with high voltage, and forming a very fine electron beam by focusing lens, such that the electron beam strikes a phosphor screen, and then phosphors emits light after being struck by the electron beam in a high speed.

At present, the mainstream liquid crystal display (LCD) liquid crystal display is a thin film transistor liquid crystal display (TFT-LCD), which is derived from the development of the original liquid crystal display technology, and works in a principle completely different from the CRT. The LCD is constructed by placing a liquid crystal cell in two parallel glass substrates, forming a thin film transistor (TFT) on the lower glass substrate, and forming a color filter (CF) on the upper glass substrate.

In a TFT-LCD active liquid crystal display, each sub-pixel has a TFT with a gate connected to a horizontal scanning line, a drain connected to a vertical data line, and a source connected to a pixel electrode. Applying a sufficient voltage on the horizontal scanning line causes all the TFTs on the horizontal scanning line to be turned on. At this time, the pixel electrodes on the horizontal scanning line are connected to the data lines in a vertical direction, thereby writing display voltage signals into the pixels, to control a direction of rotation of the liquid crystal molecules by a variation of the voltage and signal on the TFT, thereby realizing the purpose of controlling whether the polarized light of each pixel is emitted or not to achieve the display purpose. The TFT liquid crystal is provided with a semiconductor switch for each pixel, so that any one of the pixels can be individually controlled, and the liquid crystal material is sandwiched between the TFT glass layer and the color filter layer, wherein direction of rotation of the liquid crystal molecules is controlled by changing the voltage value that stimulates the liquid crystals, thereby controlling whether the polarized light of each pixel is emitted or not to achieve the display purpose, and controlling the intensity and color of the last appearing light.

Current gate driver on array (GOA) technology directly forms a gate drive circuit on an array panel, which can replace an external driver IC of the gate, thereby reducing the cost to a certain extent. Meanwhile, because of the high integration, the panel can be made to have a thinner frame. Based on the advantages of a narrow frame and low cost, the gate driver on array (GOA) technology has been widely used. However, due to the variety of GOA signals, wires in a GOA region need to be frequently replaced through via holes, resulting in a risk of electrochemical corrosion, and especially when indium tin oxide on a surface of the GOA region is not protected by an insulating layer, the risk of electrochemical corrosion is even greater. Therefore, there is an urgent need to find a novel type of liquid crystal display panel to avoid the above problems.

### SUMMARY OF INVENTION

An object of the present invention is to provide a liquid crystal display panel and a display device thereof, which are capable of solving the problem that the GOA region in the current liquid crystal display panel is susceptible to electrochemical corrosion.

In order to solve the above problems, an embodiment of the present invention provides a liquid crystal display panel, including: a display area and a non-display area surrounding the display area; an array substrate provided with a first electrode layer; a color filter substrate disposed opposite to the array substrate, and provided with a second electrode layer; the second electrode layer of the non-display area including a plurality of electrode line segments spaced apart from each other; a liquid crystal layer disposed between the array substrate and the color filter substrate; and a sealant layer disposed around the liquid crystal layer.

Further, the array substrate further includes a first metal layer and a second metal layer, and the first metal layer and the second metal layer are connected with each other through the first electrode layer.

Further, a gap between the electrode line segments of the second electrode layer is disposed corresponding to the first metal layer.

Further, a gap between the electrode line segments of the second electrode layer is disposed corresponding to the second metal layer.

Further, one of the electrode line segments of the second electrode layer away from the display area is served as a ground electrode.

Further, the liquid crystal display panel further includes: a first polyimide layer disposed on a side of the first electrode layer facing the color filter substrate; and a second polyimide layer disposed on a side of the second electrode layer facing the array substrate.

Further, a gap between the electrode line segments of the second electrode layer is filled with a material same as that used for the second polyimide layer.

Further, a gap between the electrode line segments of the second electrode layer is further filled with a material same as that used for the sealant layer.

Further, a black matrix layer disposed on a side surface of the second electrode layer away from the array substrate.

Another embodiment of the present invention also provides a display device including the liquid crystal display panel of the present invention.

The present invention relates to a liquid crystal display panel and a display device thereof. The present invention removes one of the electrodes that form an electrolytic cell by setting a second electrode layer of the non-display area into a plurality of electrode line segments spaced apart from each other, and also reduces a relative area of the second electrode layer to the first electrode layer, such that electrochemical corrosion of a fan-out area caused by formation of the electrolytic cell can be avoided, and thus the reliability of the product is improved. Further, since the gap between the electrode line segments of the second electrode layer is filled with the material same as that used for the second polyimide layer, the thickness of the second polyimide layer is increased, such that protection of second the electrode layer is increased, ensuring a normal conversion of the signal and improving the reliability of the product.

### BRIEF DESCRIPTION OF DRAWINGS

In order to more clearly illustrate the embodiments or the technical solutions of the existing art, the drawings illustrating the embodiments or the existing art will be briefly described below. Obviously, the drawings in the following description merely illustrate some embodiments of the present invention. Other drawings may also be obtained by those skilled in the art according to these figures without paying creative work.

FIG. 1 is a schematic structural view of a liquid crystal display panel of the present invention.

Elements in the drawings are designated by reference numerals listed below.
100 liquid crystal display panel
101 display area
102 non-display area
1 first substrate
2 gate insulating layer
3 passivation layer
4 first electrode layer
5 first polyimide layer
6 second polyimide layer
7 liquid crystal layer
8 second electrode layer
9 black matrix layer
10 the second substrate
11 sealant layer
21 first metal layer
31 second metal layer

### DETAILED DESCRIPTION OF PREFERRED EMBODIMENTS

The preferred embodiments of the present invention are described in detail below with reference to the accompanying drawings, in which FIG. Those skilled in the art will more readily understand how to implement the invention. The present invention may, however, be embodied in many different forms and embodiments, and the scope of the invention is not limited to the embodiments described herein.

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references.

In the drawings, the spatially relative terms are intended to encompass different orientations in addition to the orientation as depicted in the figures. Moreover, the size and thickness of each component shown in the drawings are arbitrarily shown for ease of understanding and description, and the invention does not limit the size and thickness of each component.

When a component is described as “on” another component, the components are formed in direct contact, and may also include embodiments in which additional features may be formed interposing the first and second features, such that the first and second features may not be in direct contact. When a component is described as “installed to” or “connected to” another component, it can be understood that a component is “directly installed” or “directly connected” to another component, or a component is “ installed to” or “connected with” another component through an intermediate component.

### Embodiment 1

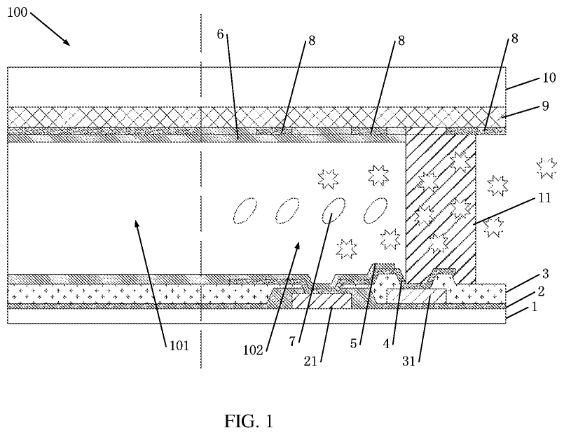

As shown in FIG. 1, a liquid crystal display panel 100 includes a display area 101 and a non-display area 102 surrounding the display area 101. The liquid crystal display panel 100 of the non-display area 102 includes an array substrate, a color filter substrate, a liquid crystal layer 7 and a sealant layer 11, wherein the color filter substrate is disposed opposite to the array substrate, the liquid crystal layer 7 is disposed between the array substrate and the color filter substrate, and the sealant layer 11 is disposed around the liquid crystal layer 7.

As shown in FIG. 1, the array substrate includes: a first substrate 1, a gate insulating layer 2, a passivation layer 3, a first electrode layer 4, and a first polyimide layer 5.

As shown in FIG. 1, the gate insulating layer 2 is disposed on the first substrate 1, and the first metal layer 21 is disposed in the gate insulating layer 2. The gate insulating (GI) layer 2 is an insulating layer between a gate metal and a semiconductor Si, and made of a material including SiNx or SiOx.

The passivation layer 3 is disposed on the gate insulating layer 2, and a second metal layer 31 is disposed in the passivation layer 3. The passivation layer 3 is partially recessed downward to an upper surface of the first metal layer 21 to form a first recess. The passivation layer 3 is partially recessed downward to an upper surface of the second metal layer 31 to form a second recess. The passivation layer 3 is mainly configured to provide insulating protection, and may be made of a material including SiNx or SiOx.

The first electrode layer 4 is disposed on the passivation layer 3, the first recess, and the second recess. First, since an indium tin oxide (GI) film has high conductivity, the first metal layer 21 and the second metal layer 31 are connected by the first electrode layer 4 to form a low potential voltage. Secondly, due to the indium tin oxide (GI) film has high light transmittance, the light emitted by the backlight module can be transmitted through the first electrode layer 4 and utilized, thereby improving light use efficiency.

The first polyimide layer 5 is disposed on the first electrode layer 4. The solid content in the first polyimide layer 5 is a small molecule compound in the stock solution, which polymerizes at a high temperature to form a solid, long-chain macromolecular polyimide with many branches. Angles between the branches and the main chain in the polymer molecule are the so-called pre-tilt angles of the alignment layer. The branched groups of the polymer have strong interaction with liquid crystal molecules, and have an anchoring effect on liquid crystal molecules, so that the liquid crystals can be aligned in a pretilt direction.

As shown in FIG. 1, the color filter substrate includes a second polyimide layer 6, a second electrode layer 8, a black matrix layer 9, and a second substrate 10.

As shown in FIG. 1, wherein the second polyimide layer 6 is correspondingly disposed on the first polyimide layer 5; and the second electrode layer 8 is disposed on the second polyimide layer 6, wherein the second electrode layer 8 includes a plurality of electrode line segments spaced apart from each other, the black matrix layer 9 is disposed on a side surface of the second electrode layer 8 away from the array substrate, and the second substrate 10 is disposed on the black matrix layer 9.

As shown in FIG. 1, the electrode line segments of the second electrode layer 8 are spaced apart from each other, wherein a gap between the electrode line segments of the second electrode layer 8 is disposed corresponding to the first metal layer 21. The gap between the electrode line segments of the second electrode layer 8 is disposed corresponding to the second metal layer 31. Since the positions of the first metal layer 21 and the second metal layer 31 are extremely susceptible to erosion compared to other portions, a purpose of this arrangement is mainly to remove parts of the second metal layer 31 corresponding to the first metal layer 21 and the second metal layer 31, thus avoiding the formation of an electrolytic cell, thereby avoiding electrochemical corrosion of the via holes in the GOA region and improving the reliability of the product.

As shown in FIG. 1, one of the electrode line segments of the second electrode layer 8 away from the display area 101 is served as a ground electrode, thereby making the potential of the entire liquid crystal display panel 100 more stable.

As shown in FIG. 1, the gap between the electrode line segments of the second electrode layer 8 is filled with a material same as that used for the second polyimide layer 6, and is also filled with a material same as that used for the sealant layer 11. Mainly because there is a gap between the electrode line segments of the second electrode layer 8, an undulating topography is formed, and the polyimide material used in the second polyimide layer 6 is more likely to accumulate at the via holes, resulting in an increased thickness of the second polyimide layer 6 at via holes, so that the protection effect on the second indium tin oxide layer 8 is increased, which ensures that the signal is normally converted, and improves the reliability of the product.

The present invention also provides a display device including the liquid crystal display panel 100 of the present invention.

The liquid crystal display panel and the display device provided by the present invention have been described in detail above. It is understood that the exemplary embodiments described herein are to be considered as illustrative only, and are not intended to limit the invention. Descriptions of features or aspects in each exemplary embodiment should generally be considered as suitable features or aspects in other exemplary embodiments. While the invention has been described with reference to the preferred embodiments thereof, various modifications and changes can be made by those skilled in the art. The present invention is intended to cover such modifications and variations within the scope of the appended claims, and any modifications, equivalents, and modifications within the spirit and scope of the present invention are intended to be included within the scope of the present invention.

What is claimed is:

1. A liquid crystal display panel, comprising:
a display area and a non-display area surrounding the display area;
an array substrate provided with a first electrode layer;
a color filter substrate disposed opposite to the array substrate, and provided with a second electrode layer; the second electrode layer of the non-display area comprising a plurality of electrode line segments spaced apart from each other;
a liquid crystal layer disposed between the array substrate and the color filter substrate; and
a sealant layer disposed around the liquid crystal layer.

2. The liquid crystal display panel according to claim 1, wherein the array substrate further comprises a first metal layer and a second metal layer, and the first metal layer and the second metal layer are connected with each other through the first electrode layer.

3. The liquid crystal display panel according to claim 2, wherein a gap between the electrode line segments of the second electrode layer is disposed corresponding to the first metal layer.

4. The liquid crystal display panel according to claim 2, wherein a gap between the electrode line segments of the second electrode layer is disposed corresponding to the second metal layer.

5. The liquid crystal display panel according to claim 1, wherein one of the electrode line segments of the second electrode layer away from the display area is served as a ground electrode.

6. The liquid crystal display panel according to claim 1, further comprising:
a first polyimide layer disposed on a side of the first electrode layer facing the color filter substrate; and
a second polyimide layer disposed on a side of the second electrode layer facing the array substrate.

7. The liquid crystal display panel according to claim 6, wherein a gap between the electrode line segments of the second electrode layer is filled with a material same as that used for the second polyimide layer.

8. The liquid crystal display panel according to claim 7, wherein a gap between the electrode line segments of the second electrode layer is further filled with a material same as that used for the sealant layer.

9. The liquid crystal display panel according to claim 1, further comprising:
a black matrix layer disposed on a side surface of the second electrode layer away from the array substrate.

10. A display device, comprising the liquid crystal display panel according to claim 1.
